(19) United States
(12) Patent Application Publication
(10) Pub. No.: US 2014/0142764 A1
(43) Pub. Date: May 22, 2014

(54) FAN ROTATIONAL SPEED CONTROL SYSTEM AND METHOD FOR CONTROLLING ROTATIONAL SPEED OF FAN

(71) Applicants: INVENTEC (PUDONG) TECHNOLOGY CORPORATION, (US); INVENTEC CORPORATION, Taipei City (TW)

(72) Inventor: Chia-Hsiang Chen, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/785,418

(22) Filed: Mar. 5, 2013

(30) Foreign Application Priority Data
Nov. 20, 2012 (CN) 201210470108.8

(51) Int. Cl. G05D 23/19

(52) U.S. Cl. CPC G05D 23/19
USPC 700/276

(57) ABSTRACT

A fan rotational speed control system is operable to control at least a fan and includes a baseboard management controller (BMC), a complex programmable logic device (CPLD), and a switching circuit. The BMC is operable to output a fan pulse wave signal and a Heart bit. The CPLD is operable to receive the Heart bit and determine whether the BMC is abnormal based on the Heart bit. The CPLD is operable to generate and output a switching signal and a take-over pulse wave signal when the BMC is abnormal. The switching circuit is operable to receive and output the fan pulse wave signal when the BMC is normal, and the switching circuit is operable to receive the switching signal and the take-over pulse wave signal to output the take-over pulse wave signal when the BMC is abnormal.

### RELATED APPLICATIONS

This application claims priority to China Application Serial Number 201210470108.8, filed Nov. 20, 2012, which is herein incorporated by reference.

### BACKGROUND

1. Field of Invention

The invention relates to a control system and a control method. More particularly, the invention relates to a fan rotational speed control system and a method for controlling a rotational speed of a fan.

2. Description of Related Art

With the development of science and technology, current server systems often include numerous electronic computing devices. When these electronic computing devices are in operation, a large amount of heat will be generated, potentially causing breakdown or damage to the electronic computing devices without a suitable heat dissipation device.

Therefore, in current server systems, multiple thermal sensors, a baseboard management controller (BMC for short), and multiple heat dissipation fans are configured to control the temperature within a server system. In short, the thermal sensors are operable to pass detected temperature back to the BMC, and then the BMC is operable to adjust the rotational speed of individual fans based on this temperature, so as to achieve the purpose of effective heat dissipation.

However, this kind of design is not perfect; an essential reason is that it is possible that an unexpected error would occur. If this error occurs when rotational speed control pins of the heat dissipation fans in the system are all at a High state, then all the fans will rotate at a full speed. In this case, although the system will not be damaged due to overheating, not all the fans are required to rotate at the full speed for the heat dissipation, and excessive electrical power required to be consumed at this time will cause unnecessary waste. Alternatively, if the aforementioned error occurs when the rotational speed control pins of the heat dissipation fans in the system are all at a Low state, then all the fans will stop rotating, so that a probability of the system being damaged due to an excessive temperature is increased significantly. Whether the aforementioned fans are at an active High or at an active Low is determined depending on an individual circuit design choices.

Therefore, it can be known that a novel heat dissipation method is urgently needed in the related field, so that the novel heat dissipation method can effectively control the temperature within the server system; more preferably, it is desirable that this kind of heat dissipation method effectively control the rotational speed of the individual fan to avoid a damage to a hardware device even when the BMC is functioning abnormally.

### SUMMARY

The invention provides a fan rotational speed control system and a method for controlling a rotational speed of a fan, so as to effectively control a temperature within a server system.

To achieve the aforementioned purpose, a technical aspect of the invention relates to a fan rotational speed control system, and the fan rotational speed control system is operable to control at least one fan. The aforementioned fan rotational speed control system includes a baseboard management controller (BMC for short), a complex programmable logic device, and a switching circuit. In structure, the BMC is electrically coupled to the at least one fan. The complex programmable logic device is electrically coupled to the BMC. The switching circuit is electrically coupled to the at least one fan, the BMC, and the complex programmable logic device.

In operation, the BMC is operable to output a fan pulse wave signal and is a Heart bit (or Heart beat). The complex programmable logic device is operable to receive the Heart bit and determine whether the BMC is in an abnormal state based on the Heart bit, and the complex programmable logic device is used to generate and output a switching signal and a take-over pulse wave signal when the BMC is abnormal. The switching circuit is operable to receive and output the fan pulse wave signal when the BMC is normal, and the switching circuit is operable to receive the switching signal and the take-over pulse wave signal to output the take-over pulse wave signal when the BMC is abnormal.

According to an embodiment of the invention, the aforementioned BMC is operable to output a starting signal to the complex programmable logic device after being enabled.

According to another embodiment of the invention, the aforementioned BMC is operable to output a current rotational speed signal of the fan to the complex programmable logic device.

According to still another embodiment of the invention, the aforementioned complex programmable logic device includes a register, a control module, and at least a pulse wave generation module. The control module is electrically coupled to the BMC and the switching circuit, while these pulse wave generation modules are electrically coupled to the control module. A fan rotational speed table is stored in the register. The control module is operable to receive the Heart bit and a current rotational speed signal and determine whether the BMC is abnormal based on the Heart bit. The control module is operable to output the switching signal and generate and output a control signal based on the fan rotational speed table and the current rotational speed signal when the control module determines that the BMC is abnormal. These pulse wave generation modules are operable to receive the control signal, and generate and output the take-over pulse wave signal based on the control signal. In addition, when the control module determines that the BMC recovers back to normal, the control module outputs a recovery signal to the switching circuit, so that the switching circuit is operable to receive and output a fan pulse wave signal.

According to yet still another embodiment of the invention, the aforementioned complex programmable logic device further includes a time control module and a switch unit. In structure, the time control module is electrically coupled to the control module, while the switch unit is electrically coupled to these pulse wave generation modules and the time control module. The time control module starts to count time when receiving the control signal, so as to generate and output a switch-on signal when a preset time is exceeded. The switch unit is operable to receive the switch-on signal and the take-over pulse wave signal, so as to output the take-over pulse wave signal based on the switch-on signal.

To achieve the aforementioned purposes, a further technical aspect of the invention relates to a method for controlling a rotational speed of a fan. The method for controlling the rotational speed of the fan is suitable for a server. This server includes a BMC, a complex programmable logic device, a switching circuit, and a fan. The aforementioned method includes the following steps:

generating and outputting a fan pulse wave signal and a Heart bit by the BMC;

receiving the Heart bit and determining whether the BMC is abnormal based on the Heart bit by the complex programmable logic device;

generating and outputting a switching signal and a take-over pulse wave signal when the complex programmable logic device determines that the BMC is abnormal; and

receiving the switching signal and the take-over pulse wave signal and outputting the take-over pulse wave signal by the switching circuit;

wherein, the switching circuit is operable to receive and output the fan pulse wave signal when the BMC is normal.

According to an embodiment of the invention, the aforementioned method for controlling the rotational speed of the fan further includes:

outputting a starting signal by the BMC after the BMC is enabled; and

outputting a current rotational signal of the fan by the BMC.

According to another embodiment of the invention, when the complex programmable logic device determines that the BMC is abnormal, the aforementioned step of generating and outputting the take-over pulse wave signal includes:

receiving the current rotational speed signal;

reading a built-in fan rotational speed table when determining that the BMC is abnormal;

generating a control signal based on the fan rotational speed table and the current rotational speed signal; and

generating and outputting the take-over pulse wave signal based on the is control signal.

According to still another embodiment of the invention, when the complex programmable logic device determines that the BMC is abnormal, the aforementioned step of generating and outputting the take-over pulse wave signal further includes:

starting to count time and determining whether a preset time is exceeded when the control signal is received;

generating a switch-on signal when determining that the preset time is exceeded; and

outputting the take-over pulse wave signal based on the switch-on signal.

According to yet still another embodiment of the invention, the aforementioned method for controlling the rotational speed of the fan further includes: when the complex programmable logic device determines that the BMC recovers back to normal, the complex programmable logic device is operable to output a recovery signal, so that the switching circuit is operable to receive and output the fan pulse wave signal.

Therefore, according to the technical content of the invention, a fan rotational speed control system and a method for controlling the rotational speed of the fan are provided in the embodiments of the invention, so as to effectively control the temperature within the server system, and no matter whether the BMC is abnormal or not, the rotational speed of the fan can be correctly controlled to avoid a damage to the hardware device.

### BRIEF DESCRIPTION OF THE DRAWINGS

In order to make the foregoing as well as other aspects, features, advantages, and embodiments of the invention more apparent, the accompanying drawings are described as follows:

FIG. 1 illustrates a circuit block diagram of a fan rotational speed control system according to an embodiment of the invention; and

FIG. 2 illustrates a schematic flow chart of a method for controlling a rotational speed of a fan according to another embodiment of the invention.

### DETAILED DESCRIPTION

In order to make the description of the disclosure more detailed and more comprehensive, the accompanying drawings and various embodiments described below can be referred to, and the same reference numbers in the drawings refer to the same or like elements. However, the embodiments described are not intended to limit the scope of the invention, while the description of a structural operation is not intended to limit the implementation order of the structural operation. Any device with equivalent functions that is generated by a structure recombined by elements shall fall into the scope of the invention.

The accompanying drawings are only used for illustration and are not drawn to scale. On the other hand, the well-known elements and steps are not described in the embodiments, so as to avoid the unnecessary limitation to the invention.

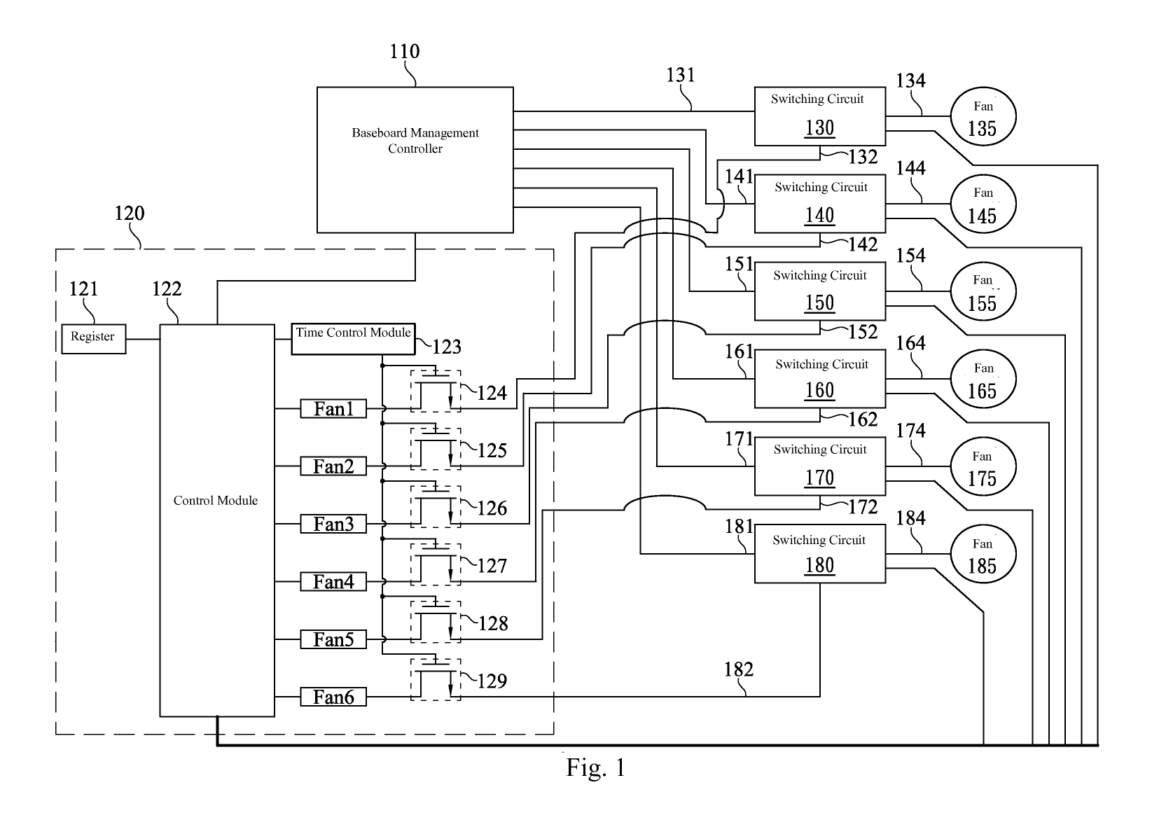

FIG. 1 illustrates a circuit block diagram of a fan rotational speed control system according to an embodiment of the invention. The fan rotational speed control system is operable to control at least a fan and it includes a baseboard is management controller (BMC) 110, a complex programmable logic device (CPLD) 120, and a plurality of switching circuits 130-180. In structure, the BMC 110 is electrically coupled to these fans. The CPLD 120 is electrically coupled to the BMC 110. The switching circuit 130 is electrically coupled to the fan, the BMC 110, and the CPLD 120.

Furthermore, take the switching circuit 130 for example, the switching circuit 130 includes an input end and an output end 134. The input end of the switching circuit 130 includes a first input port 131 and a second input port 132. In structure, the first input port 131 is electrically coupled to the BMC 110, while the second input port 132 is electrically coupled to the CPLD 120. Moreover, the output end 134 is electrically coupled to a fan 135.

In operation, the input end of the switching circuit 130 may be switched between the first input port 131 and the second input port 132. When the input end of the switching circuit 130 is switched to the first input port 131, the BMC 110 is operable to output a control signal to the switching circuit 130. The control signal is output to the fan 135 through the switching circuit 130 and the output end 134 of the switching circuit 130, and the fan 135 is operable to receive the control signal and determine the rotational speed of the fan 135 based on this control signal.

Additionally, when the input end of the switching circuit 130 is switched to the second input port 132, the CPLD 120 is operable to output the control signal to the switching circuit 130. The control signal is output to the fan 135 through the switching circuit 130 and the output end 134 of the switching circuit 130, and the fan 135 is operable to receive the control signal and to determine the rotational speed of the fan 135 based on this control signal. When the input end of the switching circuit 130 needs to be switched to the first input port 131 and when the input end of the switching circuit 130 needs to be switched to the second input port 132, that is, a switching mechanism of the fan rotational speed control system, will be described in details below.

It should be noted that, herein, the structures and functions of the switching circuits 140, 150, 160, 170, and 180 are similar to those of the switching circuit 130, for simple illustration of the invention, which is not illustrated any further herein. However, a configuration mode shown in FIG. 1 is not intended to limit the invention, and those of skills in the art can configure the switching circuits 130-180 and the fans 135, 145, 155, 165, 175, and 185 according to the actual requirements.

In order to make the switching mechanism of the fan rotational speed control system easier to understand, firstly, an initial state of the fan rotational speed control system is introduced. In the initial state, the input end of the switching circuit 130 is switched to the first input port 131, and the BMC 110 is operable to control the fan 135 through the switching circuit 130. However, after the BMC 110 is performed for a period of time, it is possible that an unexpected error would occur. At this time, another electronic element is needed to help the BMC 110 to control the fan 135, and a suitable switching mechanism is needed to switch the control right of the fan rotational speed control system from the BMC 110 to the other electronic element when the BMC 110 is abnormal.

The other aforementioned electronic element may be implemented by the CPLD 120, so that the CPLD 120 helps the BMC 110 to control the fan 135 when the BMC 110 is abnormal. In addition, an implementation of the is switching mechanism is described as follows. Firstly, the BMC 110 is operable to output the fan pulse wave signal and the Heart bit (or Heart beat) to the CPLD 120, and the CPLD 120 is operable to receive the Heart bit and determine whether the BMC 110 is abnormal based on the Heart bit. Then, when the CPLD 120 determines that the BMC 110 is abnormal, the CPLD 120 is operable to generate and output the switching signal and a take-over pulse wave signal to the switching circuit 130, and at this time, the control right of the fan rotational speed control system is switched from the BMC 110 to the CPLD 120.

Particularly, when the CPLD 120 is operable to continuously receive the Heart bit outputby the BMC 110, the CPLD 120 determines that the BMC 110 is normal. The input end of the switching circuit 130 is not switched, and the input end of the switching circuit 130 is still electrically coupled to the BMC 110. The switching circuit 130 is operable to receive and output the fan pulse wave signal to the fan 135, and the fan 135 is operable to adjust the rotational speed of the fan 135 based on the fan pulse wave signal. Herein, the control method of the switching circuits 140-180 is similar to that of the switching circuit 130. Likewise, when the CPLD 120 determines that the BMC 110 is normal, the input ends of the switching circuits 130-180 are not switched. The switching circuit 130 is operable to receive and output the fan pulse wave signal to the fans 135-185, and the fan 135 is operable to adjust the rotational speed of the fan 135 based on the fan pulse wave signal.

Moreover, when the Heart bit output by the BMC 110 is not received by the CPLD 120, the CPLD 120 determines that the BMC 110 is abnormal. The CPLD 120 is operable to output the switching signal to the switching circuit 130, and the input end of the switching circuit 130 is operable to receive the switching signal to switch from the first input port 131 to the second input port 132. At the same time, the CPLD 120 is operable to output the take-over pulse wave signal, and the take-over pulse wave signal is output to the fan 135 after being received by the switching circuit 130. The fan 135 is operable to adjust the rotational speed of the fan 135 based on the take-over pulse wave signal.

Herein, the control method of the switching circuits 140-180 is similar to that of the switching circuit 130. Likewise, when the CPLD 120 determines that the BMC 110 is abnormal, the input ends of the switching circuits 130-180 are operable to receive the switching signals for switching from the first input ports 131, 141, 151, 161, 171 and 181 to the second input ports 132, 142, 152, 162, 172 and 182. At the same time, the CPLD 120 is operable to output the take-over pulse wave signal, and the take-over pulse wave signal is output to the fans 135-185 after being received by the switching circuits 130-180. The fans 135-185 are operable to adjust the rotational speeds of the fans 135-185 based on the take-over pulse wave signal.

In this way, the aforementioned switching mechanism is applied to the fan rotational speed control system. When the BMC 110 is in a normal operation, the BMC 110 is operable to transmit the fan pulse wave signal to the fans 135-185 through the switching circuits 130-180, so as to control the rotational speeds of the fans 135-185. When the BMC 110 is abnormal, the control right of the fan rotational speed control system is switched from the BMC 110 to the CPLD 120 by respectively switching the input ends of the switching circuits 130-180 from the first input ports 131-181 to the second input ports 132-182. The CPLD 120 is operable to transmit the take-over pulse wave signal through the switching circuits 130-180, so as to control the rotational speeds of the fans 135-185. Therefore, no matter whether the BMC 110 is abnormal or not, the fan rotational speed control system can correctly control the rotational speeds of the fans 130-180.

In an embodiment, since when the BMC 110 is just started, the state of the BMC 110 is not yet stabilized, the CPLD 120 does not firstly determine whether the BMC 110 is abnormal when the BMC 110 is just started. After the BMC 110 is stabilized, for example, after the BMC is enabled, the BMC 110 is operable to output a starting signal to the CPLD 120. At this time, after receiving the starting signal, the CPLD 120 starts to receive and detect the Heart bit output by the BMC 110, so as to determine whether the BMC 110 is abnormal.

When the embodiments of the invention are implemented, the CPLD 120 may include a register 121 for storing a fan rotational speed table. The individual rotational speeds of the fans 135-185 are recorded in the fan rotational speed table. Generally, the BMC 110 is operable to monitor the operation condition of a server to determine the rotational speeds of the fans 135-185, so that the heat of the server is dissipated efficiently by the fans 135-185. However, the CPLD 120 cannot monitor the operation condition of the server. If the CPLD 120 is operable to control the rotational speeds of the fans 135-185, the heat of the server cannot be dissipated efficiently.

Therefore, when the BMC 110 is in the normal operation, the BMC 110 is operable to output the current rotational speed signals of the fans 135-185 to the CPLD 120 based on the operation condition of the server, so as to set the individual rotational speeds of the fans 135-185 recorded in the fan rotational speed table in the register 121. When the BMC 110 is abnormal and the CPLD 120 is operable to control the fans 135-185, the CPLD 120 can control the fans 135-185 based on the individual rotational speeds of the fans 135-185 recorded in the fan rotational speed table preset by the BMC 110. In this way, the CPLD 120 can also be operable to dissipate the heat of the server efficiently based on the preset fan rotational speed table.

In another embodiment, in implementation, the CPLD 120 further includes a control module 122 and at least a pulse wave generation module (for example, one of Fan1-Fan6). In structure, the control module 122 is electrically coupled to the BMC 110 and the switching circuits 130-180. The pulse wave generation modules Fan1-Fan6 are electrically coupled between the control module 122 and the switching circuits. However, the invention is not limited to the electronic element configuration mode shown in FIG. 1. Other configuration modes made to the electronic elements shown in FIG. 1 all fall into the scope of the invention without departing from the spirit of the invention.

In operation, the control module 122 is operable to receive the Heart bit and the current rotational speed signal from the BMC 110, so as to determine whether the BMC 110 is abnormal based on the Heart bit. When determining that the BMC 110 is abnormal, the control module 122 outputs the switching signal, and generates and outputs the control signal based on the fan rotational speed table and the current rotational speed signal. The pulse wave generation modules Fan1-Fan6 are operable to receive the control signal, and generate and output the take-over pulse wave signal based on the control signal. When the control module 122 determines that the BMC 110 recovers back to normal, the control module 122 is operable to output a recovery signal to the switching circuits 130-180, so that the switching circuits 130-180 are operable to receive and output the fan pulse wave signals to the fans 135-185. The fans 135-185 are operable to adjust their rotational speeds based on the fan pulse wave signals.

In still another embodiment, it is possible for the CPLD 120 to falsely determine that the BMC 110 is abnormal. Therefore, when the CPLD 120 determines that the BMC 110 is abnormal, it is not appropriate to directly deliver the control right of the fan rotational speed control system from the BMC 110 to the CPLD 120.

In order to prevent the false determination of the CPLD 120, the fan rotational speed control system of the embodiments of the invention further includes a time control module 123 and switch units (for example, switch units 124-129). When the CPLD 120 determines that the BMC 110 is abnormal, the time control module 123 is operable to receive the control signal output by the control module 122. The time control module 123 starts to count time when the control signal is received, so as to generate and output a switch-on signal when a preset time is exceeded. For example, the preset time can be 10 seconds. When the time control module 123 counts more than 10 seconds after the control signal is received, it indicates that the BMC 110 is truly abnormal, not being false determined by the CPLD 120. The control module 122 is operable to output the switching signal at this time point, so that the following situation can be avoided: when the BMC 110 recovers back to normal during the preset time, the fans 135-185 have been controlled by the CPLD 120 already.

Additionally, the control module 122 may also be operable to output the switching signal (no matter whether the preset time is exceeded or not) when the control module 122 determines that the BMC 110 is abnormal. The reason is that as long as the control module 122 determines that the BMC 110 is normal, the control module 122 will transmit the recovery signal to the switching circuits 130-180, so that the switching circuits 130-180 are operable to receive and output the fan pulse wave signals to the fans 135-185.

Moreover, the switch units 124-129 are operable to receive the switch-on signals and the take-over pulse wave signals, so as to output the take-over pulse wave signals to the fans 135-185 based on the switch-on signals. Furthermore, when the invention is implemented, the switches 124-129 may be transistors, AND gates, or other electronic elements capable of achieving a switch operation.

In yet still another embodiment, the fan rotational speed table includes duty cycles of the fans 135-185, as shown in the following table:

TABLE 1
Fan Rotational Speed Table

| Fan Number | Duty Cycle |
|---|---|
| Fan 135 | 15% |
| Fan 145 | 35% |
| Fan 155 | 45% |
| Fan 165 | 60% |
| Fan 175 | 75% |
| Fan 185 | 100% |

When the CPLD 120 determines that the BMC 110 is abnormal, the CPLD 120 is operable to output the switching signal to the switching circuits 130-180. The input ends of the switching circuits 130-180 are switched to the CPLD 120 based on the switching signals. The CPLD 120 is operable to control the individual rotational speed of each of the fans 135-185 through the switching circuits 130-180 based on the fan rotational speed table shown in Table 1.

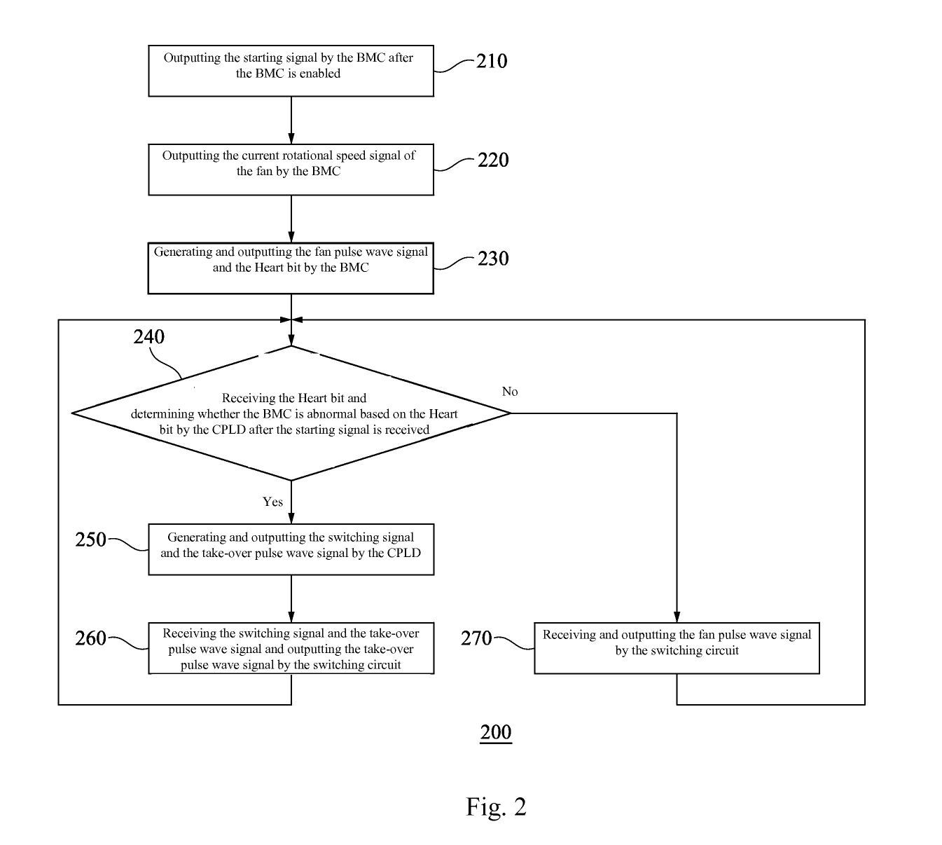

FIG. 2 illustrates a schematic flow chart of a method 200 for controlling a rotational speed of a fan according to another embodiment of the invention. The method 200 for controlling the rotational speed of the fan is suitable for the server. The server includes the BMC, the CPLD, the switching circuit and the fan. As shown in the figure, the aforementioned method includes the following steps: the BMC outputs the starting signal after being enabled (step 210); the BMC outputs the current rotational speed signal of the fan (step 220); the BMC generates and outputs the fan pulse wave signal and the Heart bit (step 230); the CPLD receives the Heart bit and determines whether the BMC is abnormal based on the Heart bit (step 240); the CPLD generates and outputs the switching signal and the take-over pulse wave signal when the CPLD determines that the BMC is abnormal (step 250); the switching circuit receives the switching signal and the take-over pulse wave signal and outputs the take-over pulse wave signal (step 260); and the switching circuit receives and outputs the fan pulse wave signal when the BMC is normal (step 270).

In order to make the method 200 for controlling the rotational speed of the fan of the embodiments of the invention easier to understand, the aforementioned flow will be exemplarily described together with reference to FIG. 1 herein. Firstly, the steps 210 and 240 are used for preventing the following situation: when the BMC 110 is just started, the state of the BMC 110 is not yet stabilized, and the CPLD 120 may make a false determination, as described in details below. Since when the BMC 110 is just started, the state of the BMC 110 is not yet stabilized, the CPLD 120 does not firstly determine whether the BMC 110 is abnormal when the BMC 110 is just started. When the BMC 110 is enabled as shown in the step 210, the BMC 110 is operable to output the starting signal to the CPLD 120. Herein, a limitation is added in the step 240. That is, the CPLD 120 starts to receive the Heart bit output by the BMC 110 after receiving the starting signal, and determines whether the BMC 110 is abnormal based on the Heart bit. However, the invention is not limited to this, and another mode by which the BMC 110 and the CPLD 120 are cooperated with each other is shown in the steps 230 and 240.

In the step 230, the BMC 110 is operable to generate and output the fan pulse wave signal and the Heart bit to the CPLD 120. Then, in the step 240, the CPLD 120 may not need to receive the starting signal but directly receives the Heart bit, and determines whether the BMC 110 is abnormal based on the Heart bit.

Moreover, the meaning of the step 220 is that, when the BMC 110 is in the normal operation, the BMC 110 is operable to output the current rotational speed signal of the fan based on the operation condition of the server, so as to set the individual rotational speeds of the fans 135-185 recorded in the fan rotational speed table within the CPLD 120; when the BMC 110 is abnormal and the CPLD 120 is operable to control the fans 135-185, the CPLD 120 controls the fans 135-185 based on the individual rotational speeds of the fans 135-185 recorded in the fan rotational speed table preset by the BMC 110. Therefore, the CPLD 120 may also be operable to efficiently dissipate the heat of the server based on the preset fan rotational speed table.

When the CPLD 120 determines that the BMC 110 is abnormal, as shown in the step 250, the CPLD 120 is operable to generate and output the switching signal and the take-over pulse wave signal. Subsequently, as shown in the step 260, the switching circuits are operable to receive the switching signals and the take-over pulse wave signals, and output the take-over pulse wave signals to the fans 135-185. The fans 135-185 are operable to adjust the rotational speeds of the fans 135-185 based on the take-over pulse wave signals. After the step 260 is performed, the step 240 is looped back for performing. In addition, when the CPLD 120 determines that the BMC 110 recovers back to normal, the CPLD 120 is operable to output the recovery signal, so that the switching circuits 130-180 are operable to receive and output the fan pulse wave signals.

Moreover, after the step 240, when the CPLD 120 determines that the BMC 110 is normal, as shown in the step 270, the switching circuits are operable to receive and output the fan pulse wave signals to the fans 135-185. The fans 135-185 are operable to adjust the rotational speeds of the fans 135-185 based on the fan pulse wave signals. After the step 270 is performed, the step 240 is looped back for performing, and the CPLD 120 is operable to continuously monitor the BMC 110.

In an embodiment, the step 250 includes: the current rotational speed signal is received; the built-in fan rotational speed table is read when the BMC is determined abnormal; the control signal is generated based on the fan rotational speed table and the current rotational speed signal; and the take-over pulse wave signal is generated and output based on the control signal. When the step is implemented, the control module 122 is operable to receive the Heart bit and the current rotational speed signal from the BMC 110, so as to determine whether the BMC 110 is abnormal based on the Heart bit, and when the control module 122 determines that the BMC 110 is abnormal, it is operable to read the built-in fan rotational speed table. Then, the control module 122 is operable to generate and output the control signal based on the fan rotational speed table and the current rotational speed signal. The pulse wave generation modules Fan1-Fan6 are operable to receive the control signals, and generate and output the take-over pulse wave signals based on the control signal.

In another embodiment, the step 250 includes: the time control module 123 starts to count time and determines whether the preset time is exceeded when the control signal is received; he switch-on signal is generated when the exceeding preset time is determined; and the take-over pulse wave signal is output based on the switch-on signal. This step is used for preventing the false determination of the CPLD 120, and the mechanism thereof is described as follows. It is possible for the CPLD 120 to false determine that the BMC 110 is abnormal. Therefore, when the CPLD 120 determines that the BMC 110 is abnormal, it is not appropriate to directly deliver the control right of the fan rotational speed control system from the BMC 110 to the CPLD 120.

In order to prevent the false determination of the CPLD 120, when the CPLD 120 determines that the BMC 110 is abnormal, the time control module 123 is operable to receive the control signal output by the control module 122. The time control module 123 starts to count time when the control signal is received, and the time control module 123 is operable to generate and output the switch-on signal when the time control module 123 determines that the preset time is exceeded. For example, if the preset time is 10 seconds, and when the time control module 123 counts more than 10 seconds after the control signal is received, it indicates that the BMC 110 is truly abnormal, not being false determined by the CPLD 120. At this time, the switch units 124-129 are operable to output the take-over pulse wave signals to the fans 135-185 based on the switch-on signal, and the fans 135-185 are operable to adjust the rotational speeds of the fans 135-185 based on the take-over pulse wave signals.

The methods for controlling the rotational speed of the fan as described above can all be performed by a software, hardware, and/or firmware. For example, if the performance speed and accuracy is a primary consideration, then basically the hardware and/or the firmware can be primarily selected; if the design flexibility is a primary consideration, then basically the software can be primarily selected; alternatively, the cooperation of the software, hardware and firmware can be employed. It should be understood that, among these examples above, no example is better than other examples and they are not intended to limit the invention, and those of skills in the art should design the examples flexibly as needed at the moment.

Moreover, those of skills in the art should understand that, each step in the method for controlling the rotational speed of the fan is named according to the function performed by the each step in the method, which is only used for making the technology of the disclosure more apparent and is not intended to limit these steps. Each step is integrated into a same step or divided into multiple steps, and alternatively any step is incorporated into another step to perform. All of the above still belong to the implementation of the disclosure.

It can be seen from the implementation of the invention described above that the application of the invention has the following advantages. A fan rotational speed control system and a method for controlling the rotational speed of the fan are provided in the embodiments of the invention, so as to effectively control the temperature within the server system, and no matter whether the BMC is abnormal or not, the rotational speed of the fan can be correctly controlled to avoid the damage to the hardware device.

Although the invention has been disclosed with reference to the embodiments above, these embodiments are not intended to limit the invention. Those of skills in the art can make various variations and modifications without departing from the spirit and scope of the invention. Therefore, the scope of the invention shall be defined by the appended claims.

What is claimed is:

1. A fan rotational speed control system, wherein the fan rotational speed control system is operable to control at least a fan and comprises:
a baseboard management controller, electrically coupled to the fan, wherein the baseboard management controller is operable to output a fan pulse wave signal and a Heart bit;
a complex programmable logic device, electrically coupled to the baseboard management controller, wherein the complex programmable logic device is operable to receive the Heart bit and determine whether the baseboard management controller is abnormal based on the Heart bit, so as to generate and output a switching signal and a take-over pulse wave signal when the baseboard management controller is abnormal; and
a switching circuit, electrically coupled to the fan, the baseboard management controller and the complex programmable logic device, wherein the switching circuit is operable to receive and output the fan pulse wave signal when the baseboard management controller is normal, while the switching circuit is operable to receive the switching signal and the take-over pulse wave signal to output the take-over pulse wave signal when the baseboard management controller is abnormal.

2. The fan rotational speed control system of claim 1, wherein the baseboard management controller is operable to output a starting signal to the complex programmable logic device after being enabled.

3. The fan rotational speed control system of claim 1, wherein the baseboard management controller is operable to output a current rotational speed signal of the fan to the complex programmable logic device.

4. The fan rotational speed control system of claim 3, wherein the complex programmable logic device comprises:
a register, operable to store a fan rotational speed table;
a control module, electrically coupled to the baseboard management controller and the switching circuit, wherein the control module is operable to receive the Heart bit and the current rotational speed signal, so as to determine whether the baseboard management controller is abnormal based on the Heart bit, while the control module is operable to output the switching signal, and generate and output a control signal based on the fan rotational speed table and the current rotational speed signal when the control module determines that the baseboard management controller is abnormal; and
at least a pulse wave generation module, electrically coupled to the control module, wherein the pulse wave generation module is operable to receive the control signal, and generate and output the take-over pulse wave signal based on the control signal;
wherein, when the control module determines that the baseboard management controller recovers back to normal, the control module outputs a recovery signal to the switching circuit, so that the switching circuit is operable to receive and output the fan pulse wave signal.

5. The fan rotational speed control system of claim 4, wherein the complex programmable logic device further comprises:
a time control module, electrically coupled to the control module, wherein the time control module starts to count time when receiving the control signal, so as to generate and output a switch-on signal when a preset time is exceeded; and
a switch unit, electrically coupled to the pulse wave generation module and the time control module, and is operable to receive the switch-on signal and the take-over pulse wave signal, so as to output the take-over pulse wave signal based on the switch-on signal.

6. A method for controlling a rotational speed of a fan, wherein the method is suitable for a server, the server comprises a baseboard management controller, a complex programmable logic device, a switching circuit and a fan, and the method for controlling the rotational speed of the fan comprises:
generating and outputting a fan pulse wave signal and a Heart bit by the baseboard management controller;
receiving the Heart bit and determining whether the baseboard management controller is abnormal based on the Heart bit by the complex programmable logic device;
generating and outputting a switching signal and a take-over pulse wave signal when the complex programmable logic device determines that the baseboard management controller is abnormal; and
receiving the switching signal and the take-over pulse wave signal and outputting the take-over pulse wave signal by the switching circuit;
wherein, when the baseboard management controller is normal, the switching circuit is operable to receive and output the fan pulse wave signal.

7. The method for controlling the rotational speed of the fan of claim 6, further comprising:
outputting a starting signal by the baseboard management controller after the baseboard management controller is enabled; and
outputting a current rotational speed signal of the fan by the baseboard management controller.

8. The method for controlling the rotational speed of the fan of claim 7, wherein when the complex programmable logic device determines that the baseboard management controller is abnormal, the step of generating and outputting the take-over pulse wave signal comprises:
receiving the current rotational speed signal;
reading a built-in fan rotational speed table when determining that the baseboard management controller is abnormal;
generating a control signal based on the fan rotational speed table and the current rotational speed signal; and
generating and outputting the take-over pulse wave signal based on the control signal.

9. The method for controlling the rotational speed of the fan of claim 8, wherein when the complex programmable logic device determines that the baseboard management controller is abnormal, the step of generating and outputting the take-over pulse wave signal further comprises:
starting to count time and determining whether a preset time is exceeded when the control signal is received;
generating a switch-on signal when determining that the preset time is exceeded; and
outputting the take-over pulse wave signal based on the switch-on signal.

10. The method for controlling the rotational speed of the fan of claim 6, further comprising: when the complex programmable logic device determines that the baseboard management controller recovers back to normal, the complex programmable logic device is operable to output a recovery signal, so that the switching circuit is operable to receive and output the fan pulse wave signal.
